(19) United States
(12) Patent Application Publication
(10) Pub. No.: US 2025/0272030 A1
(43) Pub. Date: Aug. 28, 2025

(54) PROCESSING APPARATUS, PROCESSING METHOD, AND STORAGE MEDIUM

(71) Applicant: CANON KABUSHIKI KAISHA, Tokyo (JP)

(72) Inventor: YOSHITAKA OBA, CHIBA (JP)

(21) Appl. No.: 19/056,557

(22) Filed: Feb. 18, 2025

(30) Foreign Application Priority Data
Feb. 22, 2024 (JP) 2024-025192

(51) Int. Cl. G06F 3/12

(52) U.S. Cl. CPC G06F 3/1204; G06F 3/1254

(57) ABSTRACT

An image forming apparatus selects, from already-existing media, a medium with a characteristic similar to a characteristic of a sheet included in a sheet type detection result. The image forming apparatus creates a new user defined medium by combining details of the characteristic of the sheet included in the sheet type detection result and a print adjustment value set to the selected medium.

### BACKGROUND

### Field of the Disclosure

The present disclosure relates to a processing apparatus, a processing method, and a storage medium, and in particular, to those suitably used for forming an image on a sheet.

### Description of the Related Art

In image forming apparatuses, values of print adjustment parameters for a conveyance speed, a fixing temperature, an image position, and the like are set based on a type of sheet such as normal paper and thick paper, to enhance the quality of an image to be formed on a sheet. Japanese Patent Application Laid-open No. 2022-026815 discusses a technique for selecting print adjustment values prepared in advance for individual sheet types.

However, with the technique discussed in Japanese Patent Application Laid-open No. 2022-026815, a user needs to check and manually set the respective print adjustment values of print adjustment parameters at a printing time. Accordingly, it is not easy to set the print adjustment parameter values suitable for a sheet type.

### SUMMARY

The present disclosure is made in consideration of the above-described issue, and is directed to reducing the user's workload when the user sets print adjustment parameter values suitable for a sheet type.

According to an aspect of the present disclosure, a processing apparatus includes at least one memory storing instructions and at least one processor that, upon execution of the stored instructions, is configured to operate as an identification unit configured to identify a characteristic of a sheet, based on a result of detection performed by a detection unit configured to detect a physical quantity having a value corresponding to the characteristic of the sheet while the sheet is being conveyed, and a creation unit configured to create sheet type information including information indicating the characteristic of the sheet, and a print adjustment parameter corresponding to the characteristic, wherein the creation unit creates new sheet type information, based on the characteristic of the sheet identified by the identification unit, and the print adjustment parameter included in sheet type information including a characteristic similar to the characteristic identified by the identification unit, from already-existing sheet type information.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an image forming apparatus, more specifically to a configuration related to sheet conveyance.

FIGS. 2A and 2B are block diagrams each illustrating a configuration of the image forming apparatus, more specifically to a configuration related to control.

FIG. 3 is a diagram illustrating a configuration of a media sensor.

FIGS. 4A, 4B, 4C, and 4D are diagrams each illustrating a display screen displayed when a basic medium or a user defined medium is created.

FIG. 5 is a flowchart illustrating an example of creation processing of the user defined medium according to a first exemplary embodiment.

FIGS. 6A, 6B, and 6C are diagrams each illustrating a display screen displayed when a new user defined medium is created.

FIG. 7 is a flowchart illustrating a second example of creation processing of a user defined medium.

FIG. 8 is a diagram illustrating a display screen of a sheet type list.

FIG. 9 is a flowchart illustrating a third example of creation processing of a user defined medium.

FIG. 10 is a diagram illustrating a login screen.

### DESCRIPTION OF THE EMBODIMENTS

Hereinbelow, exemplary embodiments of the present disclosure will be described with reference to the accompanying drawings. Note that the following exemplary embodiments are not necessarily intended to limit the disclosure, and also that not all the combinations of the features described in the following exemplary embodiments are necessarily essential for the solution of the present disclosure.

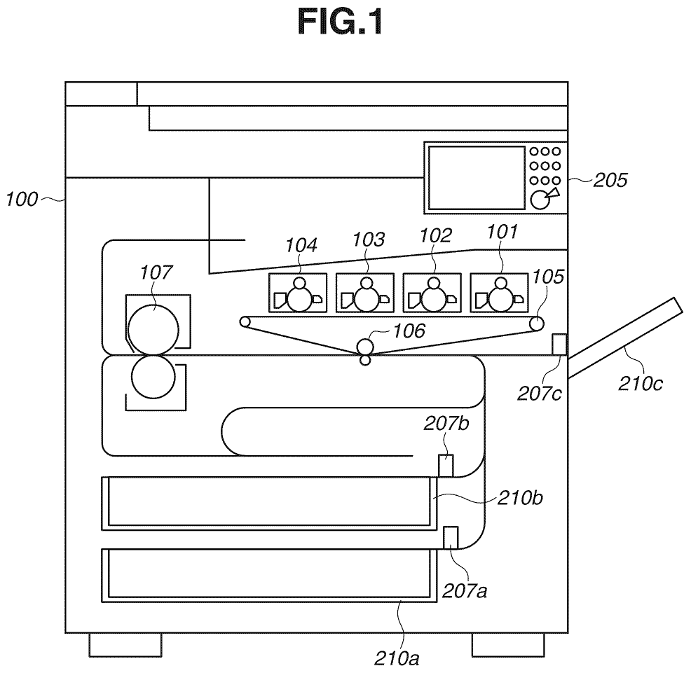

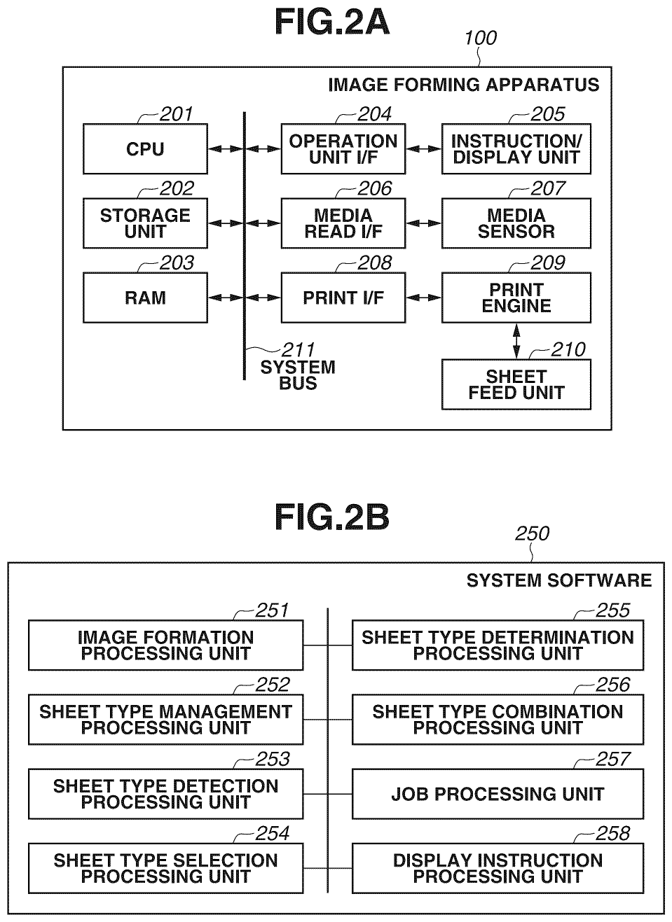

FIG. 1 is a diagram illustrating an example of a configuration related to sheet conveyance in a configuration of an image forming apparatus 100 according to a first exemplary embodiment. FIGS. 2A and 2B are diagrams each illustrating an example of a configuration related to control in the image forming apparatus 100 according to the present exemplary embodiment. In each diagram, only configurations to be used for descriptions are illustrated in a simplified manner as appropriate.

In FIG. 2A, a central processing unit (CPU) 201 is a control unit for controlling the entire image forming apparatus 100. The image forming apparatus 100 may include one or more dedicated hardware components different from the CPU 201, and the dedicated hardware component or components may execute at least a part of the processing performed by the CPU 201. Examples of the dedicated hardware components include an application specific integrated circuit (ASIC), a field programmable gate array (FPGA), and a digital signal processor (DSP). Instead of or in addition to the CPU 201, the image forming apparatus 100 may include a hardware processor such as a graphics processing unit (GPU) different from the CPU 201.

The CPU 201 integrally controls various devices connected to a system bus 211 by loading a control program stored in a storage unit 202 into a random access memory (RAM) 203, and executing the loaded program.

The storage unit 202 stores control programs and initial values of various setting values according to the present exemplary embodiment. The CPU 201 implements procedures of image forming and flowcharts, which are described below, by executing the control programs according to the present exemplary embodiment read from the storage unit 202.

The RAM 203 stores various types of information under the control of the CPU 201. A first area of the RAM 203 stores values of the print adjustment parameters used for controlling printing for different types of sheets on which an image is to be formed, which will be described below in detail. In the present exemplary embodiment, an example is provided where the sheet is paper. However, the sheet is not limited to the paper sheet. For example, the sheet may be paper other than the paper sheet (e.g., envelope), a plastic film such as an overhead projector (OHP) sheet, or a cloth sheet. In the descriptions below, the values of the print adjustment parameters are referred to as print adjustment values as appropriate.

A second memory area of the RAM 203 stores a history of sheet types (sheet type history). In the present exemplary embodiment, a description is provided of an example case in which a sheet type is determined based on a result of detection performed, by a media sensor 207a, 207b, or 207c, on a sheet fed from the corresponding one of sheet feed cassettes 210a and 210b, and a manual sheet feed tray 210c to a sheet conveyance path and being conveyed. In the descriptions below, a type of sheet (types of sheets) is referred to as a sheet type (sheet types) or a medium (media), as appropriate. In the descriptions below, in a case where the sheet feed cassettes 210a and 210b, and the manual sheet feed tray 210c do not need to be distinguished, these are collectively referred to as a sheet feed unit 210 or sheet feed units 210 as appropriate.

The RAM 203 is desirably a rewritable memory that does not need a memory holding operation. Further, as described below, the CPU 201 refers to a sheet type corresponding to the sheet feed unit 210 selected by a user from the sheet type history stored in the second memory area. As further described below, in a case where the print adjustment values corresponding to the sheet type that is referred to from the second memory area are changed by the user, the CPU 201 additionally stores the changed print adjustment values into the first memory area, as the print adjustment values corresponding to the sheet type. The print adjustment values are defined by the user.

An operation unit interface (IF) 204 controls an interface between an instruction/display unit 205 and the image forming apparatus 100.

The instruction/display unit 205 includes a user interface that is used when a user inputs various types of information. For example, the instruction/display unit 205 includes a panel capable of displaying an operation screen, and buttons. In response to receiving an instruction such as an instruction to start a print operation, the instruction/display unit 205 outputs instruction information indicating the details of the instruction to the CPU 201. For example, the instruction/display unit 205 includes a touch panel display such as a liquid crystal display connected to the image forming apparatus 100. For example, the instruction/display unit 205 receives a user input to the image forming apparatus 100, and displays a status of the image forming apparatus 100. Further, the image forming apparatus 100 may receive the instruction to start the print operation or the like from an external apparatus connected to the image forming apparatus 100 via a network (not illustrated), in addition to or instead of receiving the user's operation on the instruction/display unit 205. The external apparatus is, for example, a personal computer, a tablet terminal, or a smartphone.

In response to receiving the instruction to start the print operation, in accordance with the instruction, the CPU 201 performs control to drive a sheet feed and conveyance motor (not illustrated) to discharge (feed) and convey a sheet. The CPU 201 sets the print adjustment values to a print engine 209 via a print I/F 208, to control image formation by the print engine 209.

A media read I/F 206 controls an interface between the media sensor 207 and the image forming apparatus 100. The media sensor 207 corresponds to any one of the media sensors 207a, 207b, and 207c illustrated in FIG. 1. When the media sensors 207a, 207b, and 207c do not need to be distinguished, these are collectively referred to as the media sensor 207 or the media sensors 207.

A sheet in the sheet feed unit 210 (i.e., sheet feed cassette 210a or 210b, or manual sheet feed tray 210c) is fed from the sheet feed unit 210 to the sheet conveyance path in the image forming apparatus 100, and conveyed to the sheet conveyance path, by driving the sheet feed and conveyance motor. The media sensor 207 (i.e., media sensor 207a, 207b, or 207c) detects a physical quantity having a value corresponding to the characteristics of the sheet that is being conveyed in the sheet conveyance path. The sheet characteristics are, for example, a surface property (characteristics of the surface shape) and a thickness. The sheet characteristics are not limited thereto. For example, in addition to or instead of these characteristics, at least one of a grammage and a size (i.e., length and width) may be included in the sheet characteristics. The sheet characteristics may be expressed by numerical values or non-numerical information.

As described above, in the present exemplary embodiment, a description will be provided of a case where the CPU 201 identifies the sheet characteristics based on the detection result of the media sensor 207, and determines the sheet type based on the sheet characteristics. In the descriptions below, thus determining the sheet type is expressed as “sheet type is detected by the media sensor 207”, or simply “sheet type is detected”. Details of sheet type detection will be described below. The media sensor 207 may be provided for at least one of the sheet feed units 210. For example, the image forming apparatus 100 may have only the media sensors 207a and 207b, and may exclude the media sensor 207c. For example, the image forming apparatus 100 may have only the media sensor 207c, and may exclude the media sensors 207a and 207b.

The print I/F 208 controls an interface between the print engine 209 and the image forming apparatus 100.

The print engine 209 performs printing on a sheet based on the print adjustment values set by the CPU 201. For example, the print engine 209 includes developing devices 101 to 104, an intermediate transfer belt 105, a secondary transfer unit 106, and a laser scanner, as illustrated in FIG. 1. In accordance with the print adjustment values, the print engine 209 drives the developing devices 101 to 104, the intermediate transfer belt 105, the secondary transfer unit 106, and the laser scanner.

In addition, the CPU 201 controls a fixing unit 107 for fixing an image formed on a sheet by the print engine 209 via the print I/F 208, and monitors an output of a sheet feed cassette open/close sensor for detecting an open/close state of each of the sheet feed cassettes 210a and 210b. The CPU 201 can detect the open/close state of each of the sheet feed cassettes 210a and 210b, based on the sensor output provided from the corresponding sheet feed cassette open/close sensor.

The sheet feed cassettes 210a and 210b are devices for storing sheets to be used for printing. The manual sheet feed tray 210c is a tray on which sheets different from the sheets stored in the sheet feed cassettes 210a and 210b are placed. In response to receiving, as instruction information, a print instruction to start a print operation, the CPU 201 selects one of the sheet feed units 210. A sheet is fed to the sheet conveyance path from the sheet feed unit 210 selected by the CPU 201. In addition, depending on an optional configuration which is connected to the image forming apparatus 100, the number of the sheet feed cassettes 210a and 210b increases or decreases.

FIG. 2B is a block diagram illustrating an example of a software configuration of the image forming apparatus 100 according to the present exemplary embodiment. For example, functions of the units illustrated in FIG. 2B are implemented by the CPU 201 executing a control program loaded in the RAM 203.

FIG. 2B illustrates an example case in which system software 250 for controlling the image forming apparatus 100 includes, for example, an image formation processing unit 251, a sheet type management processing unit 252, a sheet type detection processing unit 253, and a sheet type selection processing unit 254. In FIG. 2B, the system software 250 further includes, for example, a sheet type determination processing unit 255, a sheet type combination processing unit 256, a job processing unit 257, and a display instruction processing unit 258.

When the print engine 209 outputs information on a sheet in accordance with a print job input to the image forming apparatus 100, the image formation processing unit 251 performs processing for creating an image to be formed on the sheet. In addition, the print job may be transmitted from an external apparatus to the image forming apparatus 100, or may be stored in the image forming apparatus 100. The sheet type management processing unit 252 performs processing for managing the sheet types registered in the image forming apparatus 100. The sheet type detection processing unit 253 performs processing for detecting the type of the sheet (sheet type) fed from the sheet feed unit 210.

The sheet type selection processing unit 254 performs processing for selecting a sheet type similar to the sheet type detected by the sheet type detection processing unit 253, from among the sheet types stored in the image forming apparatus 100. The sheet type determination processing unit 255 performs processing for determining whether the sheet type selected by the sheet type selection processing unit 254 is present. As described above, in the present exemplary embodiment, the case where the sheet type history is stored in the second memory area of the RAM 203 is exemplified. In this case, the sheet type determination processing unit 255 determines whether the sheet type selected by the sheet type selection processing unit 254 is stored in the second memory area of the RAM 203. In addition, the storage medium to which the sheet type history is stored is not limited to the RAM 203.

The sheet type combination processing unit 256 performs processing for combining the similar sheet type determined by the sheet type determination processing unit 255, and the sheet type detected by the sheet type detection processing unit 253.

The job processing unit 257 performs processing for managing a print job input to the image forming apparatus 100. As the management of the print job, the job processing unit 257 manages, for example, a job including the registration of the sheet type detected by the media sensor 207.

The display instruction processing unit 258 performs various types of display controls. For example, the display instruction processing unit 258 performs processing for displaying, on the instruction/display unit 205, a list of the sheet types detected by the sheet type detection processing unit 253, and the similar sheet types selected by the sheet type selection processing unit 254. In a case where a sheet type is selected by a user from the list of the sheet types displayed on the instruction/display unit 205, the display instruction processing unit 258 outputs information indicating the selected sheet type. Further, the display instruction processing unit 258 performs processing for identifying a user when the user accesses the image forming apparatus 100.

Next, an example of a basic image forming operation will be described with reference to FIGS. 1, 2A, and 2B.

In response to receiving a print operation start instruction from the instruction/display unit 205 or the like, the CPU 201 starts an operation of feeding a sheet to the sheet conveyance path from the sheet feed unit 210 specified based on the instruction. For example, in a case where the sheet feed cassette 210a or 210b is specified as the sheet feed unit 210 by the print operation start instruction, the CPU 201 drives a sheet feed pick-up roller of the sheet feed cassette 210a or 210b to rotate. In this way, the sheets stored in the sheet feed cassette 210a or 210b are fed to the sheet conveyance path one by one. For example, in a case where the manual sheet feed tray 210c is specified as the sheet feed unit 210 by the print operation start instruction, the CPU 201 drives a sheet feed roller of the manual sheet feed tray 210c to rotate. In this way, the sheets placed on the manual sheet feed tray 210c are fed to the sheet conveyance path one by one.

In a case where the sheet type setting is set to “automatic” in the print operation start instruction, the CPU 201 identifies the sheet characteristics based on the output value of the media sensor 207, and determines the sheet type based on the sheet characteristics. The CPU 201 controls the print adjustment parameters, based on the sheet type determined in this way, or the sheet type set via the instruction/display unit 205. For example, the CPU 201 optimally controls the print adjustment parameters including at least one of an image forming speed and a target temperature of the fixing unit 107.

In a case where the image forming speed is controlled, the CPU 201 controls the image forming and the sheet conveyance to be performed, for example, at speeds determined in advance based on the material of the sheet. More specifically, in a case where the sheet type is thick paper, the CPU 201 controls the image forming and the sheet conveyance to be performed, for example, at speeds half of the speeds of the image forming and the conveyance for plain paper and thin paper.

In a case where the target temperature of the fixing unit 107 is controlled, the CPU 201 sets the target temperature of the fixing unit 107 lower than that for the plain paper in a case where the sheet type is thin paper. In a case where the sheet type is thick paper, the CPU 201 sets the target temperature of the fixing unit 107 higher than that for plain paper.

The CPU 201 causes the developing devices 101, 102, 103, and 104 to start image forming operation so as to be in time for a timing at which the sheet reaches the secondary transfer unit 106. The developing device 101 is configured to form a yellow image. The developing devices 102, 103, and 104 are configured to form magenta, cyan, and black images, respectively.

After the surface of the photosensitive member of each of the developing devices 101, 102, 103, and 104 is charged by a charging roller, a latent image is formed on the surface of the photosensitive member of each of the developing devices 101, 102, 103, and 104 by a laser beam emitted from a laser scanner. The latent image formed on the surface of the photosensitive member is developed on the surface of the photosensitive member by the toner in each of the developing devices 101, 102, 103, and 104. Then, the toner images developed on the photosensitive members are transferred onto the intermediate transfer belt 105 illustrated in FIG. 1. The toner images transferred onto the intermediate transfer belt 105 are conveyed to the secondary transfer unit 106 by the rotation of the intermediate transfer belt 105.

The CPU 201 detects the position of the sheet that is being conveyed by a conveyance roller through the sheet conveyance path, by monitoring an output from a preregistration conveyance sensor. The CPU 201 controls, with a timing at which the leading end of the sheet reaches the preregistration conveyance sensor being reflected, the sheet conveyance so that the leading end of the sheet and the leading end of the toner image transferred on the intermediate transfer belt 105 match at the secondary transfer unit 106. For example, in a case where the sheet has reached the detection position of the preregistration conveyance sensor earlier than the toner image, the CPU 201 halts the sheet for a predetermined time period by a preregistration conveyance roller, and then restarts the conveyance of the sheet.

Transfer voltage is applied to the sheet and the toner image having reached the secondary transfer unit 106 as described above, and thus, the toner image is transferred onto the sheet. The sheet with the image transferred thereon is conveyed to the fixing unit 107.

The CPU 201 causes the fixing unit 107 to heat and fix the image transferred on the sheet, and then cause the sheet with the toner image (image) fixed thereon to be discharged.

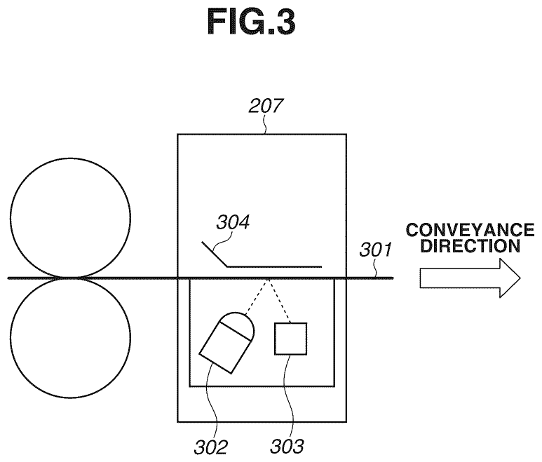

Next, an example of a configuration of the media sensor 207 will be described with reference to FIG. 3. The media sensor 207 includes a light emitting element 302 and a light receiving element 303. The light emitting element 302 is, for example, a light emitting diode (LED). The light receiving element 303 is, for example, a photodiode. The light emitting element 302 and the light receiving element 303 are arranged so that the light receiving element 303 can detect an amount of light emitted from the light emitting element 302 and reflected from the sheet. In this case, the amount of light emitted from the light emitting element 302 and reflected from the sheet is an example of a physical quantity having a value corresponding to the sheet characteristics.

The media sensor 207 is provided with a guide member 304 for guiding the sheet to the conveyance path in the media sensor 207.

The CPU 201 receives the input signal of the light receiving element 303 as the output value of the media sensor 207. The output value of the media sensor 207 varies depending on the characteristics (e.g., surface property and thickness) of the sheet. The CPU 201 can identify the sheet characteristics based on the output value of the media sensor 207, and determine the sheet type based on the identified sheet characteristics. For example, the CPU 201 determines the sheet type using a sheet type database in which information that can identify the sheet type, the sheet characteristics, and the like are mutually associated and stored. The information that can identify the sheet type is, for example, a name of the sheet (sheet type name). For example, the CPU 201 determines the sheet type by identifying the sheet characteristics based on the output value of the media sensor 207, and reading out from the sheet type database the sheet type in association with the identified sheet characteristics.

The configuration of the media sensor 207 is merely an example, and not limited to the configuration described above. For example, the media sensor 207 may have a configuration obtained by combining the light emitting element 302, the light receiving element 303, and an ultrasonic sensor such as a piezoelectric element. The media sensor 207 may have other configurations.

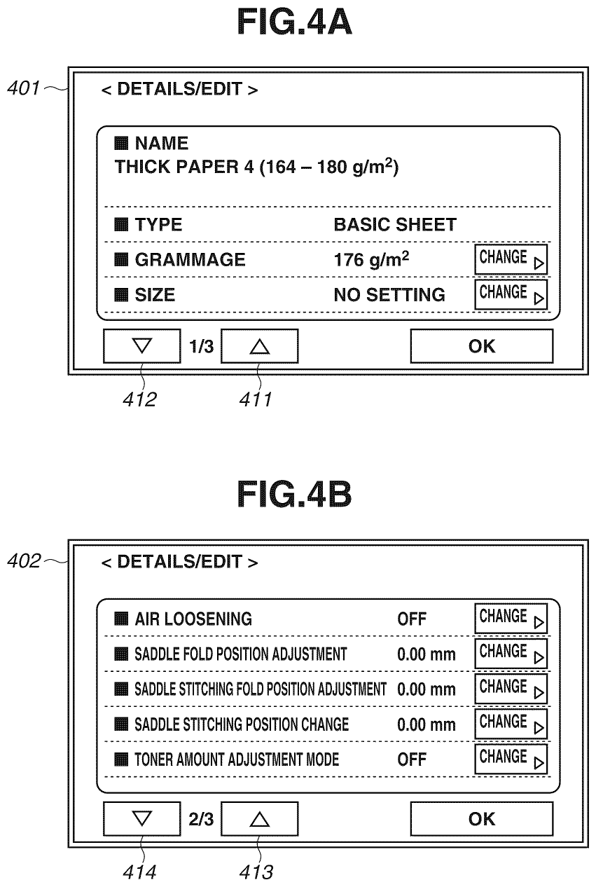

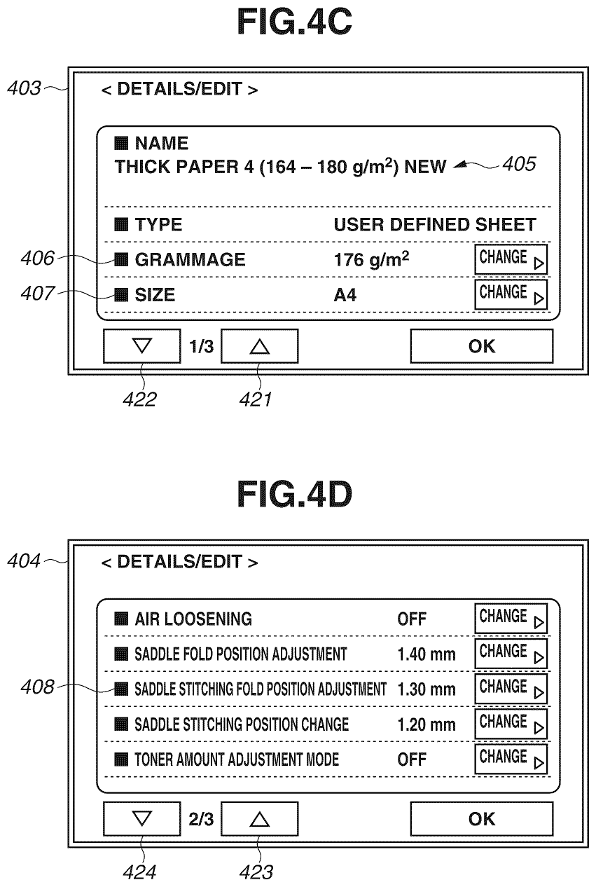

Next, with reference to FIGS. 4A, 4B, 4C, and 4D, an example of creation processing of creating the sheet type (basic media prepared in the image forming apparatus 100, and user defined media created by a user) will be described. FIGS. 4A to FIG. 4D are schematic diagrams each illustrating a screen displayed on the instruction/display unit 205.

In the present exemplary embodiment, the user defined media are sheet types set uniquely by users, and the definitions of the sheet characteristics, such as a grammage and a surface property, and the print adjustment values such as fixing temperature, can be set for each of the sheet types. In the present exemplary embodiment, an example case in which a new user defined medium is created as described below, as an example of new sheet type information, based on the print adjustment values of an already-existing medium (basic media and already-created user defined media) will be described. The print adjustment values of the basic media are stored in, for example, the first memory area of the RAM 203. The print adjustment values of the user defined media are added to and stored by the CPU 201 in, for example, the first memory area of the RAM 203.

The CPU 201 displays a screen, on the instruction/display unit 205 which displays a list of the basic media selectable by a user when a user sets a user defined medium. A basic medium list 401 illustrated in FIG. 4A, and a basic medium list 402 illustrated in FIG. 4B each are an example of a screen displaying a list of details of the basic media, which are selectable by a user when the user sets a user defined medium.

The basic medium lists 401 and 402 each are a list of the sheet characteristics and the print adjustment parameters included in a same basic medium. The display of the basic medium lists 401 and 402 is switched by, for example, pressing any of buttons 411 to 414.

When a basic medium is selected by a user's operation via the basic medium lists 401 and 402, the CPU 201 performs the following processing. Specifically, the CPU 201 displays a creation screen for a user defined medium on the instruction/display unit 205, based on the basic medium setting (details of the sheet characteristics and the print adjustment values). The creation screen for the user defined medium includes a user defined medium list 403 illustrated in FIG. 4C, and a user defined medium list 404 illustrated in FIG. 4D.

The user changes at least one of details of sheet characteristics and the print setting values in the user defined medium list 403 or 404. The CPU 201 creates a user defined medium based on the user's preference, by performing above-described change on the basic medium. The user defined medium lists 403 and 404 each are a list of the characteristics of a sheet and the print adjustment parameters included in a same user defined medium. The displays of the user defined medium lists 403 and 404 are switched by, for example, pressing any of buttons 421 to 424.

FIG. 4C illustrates an example in which a “Name” 405, a “grammage” 406, and a “Size” 407 are settable as sheet characteristics type, and FIG. 4D illustrates an example in which a “Saddle stitching fold position adjustment” 408 and the like are settable as the print adjustment values of the sheet type. For example, there is a possibility that joint parts of sheets at a binding output time do not match, caused by individual characteristics of the image forming apparatus 100. In this case, the “Saddle stitching fold position adjustment” 408 is adjusted in advance, which can improve matching the joint parts of the sheets. In addition, the items illustrated in the user defined medium lists 403 and 404 are just examples, and the sheet type and the details thereof (setting items of sheet characteristics and print adjustment parameters) are not limited to those illustrated in FIGS. 4C and 4D.

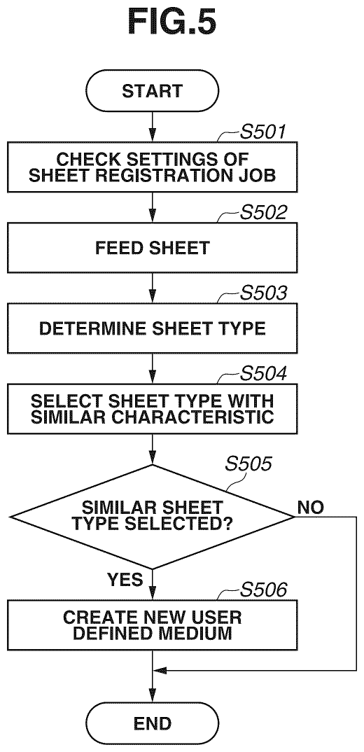

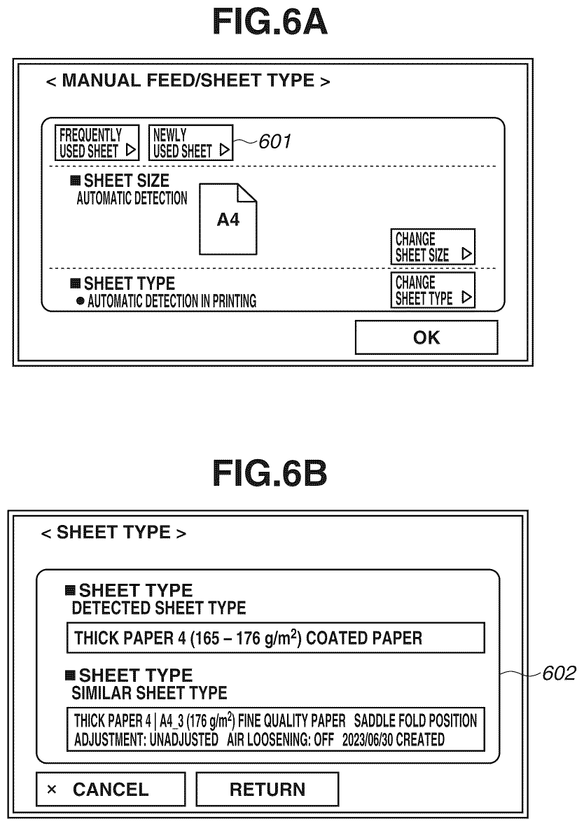

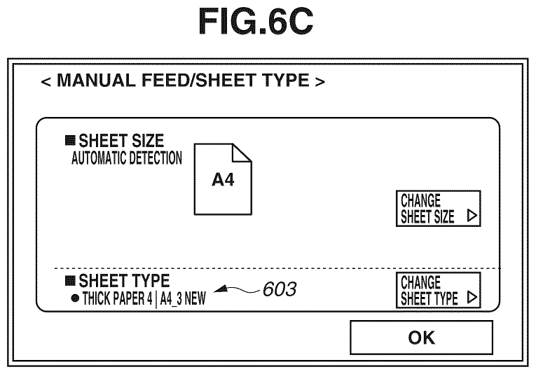

Next, with reference to FIGS. 5, 6A, 6B, and 6C, an example of processing of creating a user defined medium will be described. FIG. 5 is a flowchart illustrating an example of processing for newly creating a user defined medium using a sheet type detected by the media sensor 207. FIGS. 6A, 6B, and 6C are diagrams each schematically illustrating an example of a screen that is displayed when a user defined medium is newly created using the sheet type detected by the media sensor 207. FIGS. 6A to 6C are the schematic diagrams each illustrating a screen displayed on the instruction/display unit 205.

The flowchart illustrated in FIG. 5 is implemented by, for example, the CPU 201 reading a control program stored in the storage unit 202, loading the read control program into the RAM 203, and executing the loaded control program.

The CPU 201 starts the processing according to the flowchart illustrated in FIG. 5, in a case where a user selects a sheet type creation button 601 illustrated in FIG. 6A.

In step S501, the job processing unit 257 checks details of the settings of a sheet registration job. The sheet registration job includes a setting indicating from which of the sheet feed units 210 (sheet feed cassettes 210a, 210b, and manual sheet feed tray 210c) the sheet is to be fed. The sheet registration job includes a setting whether to register the sheet type detected by the media sensor 207.

The job processing unit 257 reads the settings of the sheet registration job and stores the settings in the RAM 203. Then, the processing proceeds to step S502.

In step S502, the job processing unit 257 feeds a sheet based on the setting of the sheet registration job. Then, the processing proceeds to step S503.

In step S503, the sheet type detection processing unit 253 operates the media sensor 207 via the media read I/F 206. The media sensor 207 detects an amount of light emitted from the light emitting element 302 and reflected from a sheet 301. The sheet type detection processing unit 253 identifies the characteristic of the sheet 301 based on the amount of the reflected light, and determines the type of the sheet 301 based on the characteristic of the sheet 301. The sheet type detection processing unit 253 stores into the RAM 203 the sheet type detection result (e.g., sheet characteristics 310 and sheet type) obtained in this way. Then, the processing proceeds to step S504.

In step S504, the sheet type selection processing unit 254 reads the sheet type detection result stored in the RAM 203. The sheet type selection processing unit 254 selects a medium with characteristics similar to the sheet characteristics included in the sheet type detection result, from among the basic media and the user defined media stored in the storage unit 202. Then, the processing proceeds to step S505.

The similar medium selected in step S504 is a medium (sheet type) to which characteristics similar to the sheet characteristics included in the sheet type detection result (sheet type) are set. In the present exemplary embodiment, a case where the number of similar media selected in step S504 is one is exemplified.

The details of the sheet characteristics included in the sheet type detection result and the details of the sheet characteristics set to the medium (sheet type) are compared, for example, for individual type of characteristics. Any medium with the details of sheet characteristics set thereto being the same as the details of the sheet characteristics included in the sheet type detection result, for all types of characteristics, from among the basic media and the user defined media, are excluded from the selection targets in step S504. All types may be all types of the sheet characteristics included in both the basic media and the user defined media, and the sheet type detection result. In this case, the sheet types included only one of the basic media and the user defined media, and the sheet type detection result are not treated as the comparison targets as to whether sheet type are the same.

In the basic media and the user defined media, the media with the details of the sheet characteristics set thereto being the same as those included in the sheet type detection result for some types can be treated as the selection targets in step S504. The media with the details of the sheet characteristics set thereto (sheet type) being different, for all the types, from the details of the sheet characteristics included in the sheet type detection result, from among the basic media and the user defined media, can be treated as the selection targets in step S504. This is because, even in such cases, there may be a case where both characteristics are similar if seen as a whole.

For example, in a case where the details of the sheet characteristics set to the medium, and the details of the sheet characteristics included in the sheet type detection result are different in surface property, but the same in grammage, the medium can be selected in step S504. In addition, the sheet characteristics set to the medium and the sheet characteristics included in the sheet type detection result are different in grammage, but the same in surface property, the medium can be selected in step S504. For the surface property and the grammage, in a case where the details of the sheet characteristics set to the medium and the details of the sheet characteristics included in the sheet type detection result are different but the difference in detail between these falls within a predetermined range, the medium can be selected in step S504.

In the present exemplary embodiment, a case where the condition for the similar media to be selected in step S504 is determined so that the number of similar media selected in step S504 narrows down to one, is exemplified.

For example, differences between the details of the sheet characteristics set to the medium and the details of the sheet characteristics included in the sheet type detection result may be evaluated to determine the medium (sheet type) selected in step S504.

In this case, the sheet type selection processing unit 254 may calculate an absolute value of the differences between the values of the sheet characteristics set to the medium and the values of the sheet characteristics included in the sheet type detection result for each type of the sheet characteristics, and calculate a weighted average value thereof. In this case, the sheet type selection processing unit 254 may determine that a medium with a minimum weighted average value, from among the basic media and the user defined media, is a medium (sheet type) selected in step S504. In a case where the details of the sheet characteristics are not expressed by numeral values, the sheet type selection processing unit 254 may simply convert the details of the characteristics into numeral values. Since the medium with a weighted average value “0” has the details of the sheet characteristics that match the details of the sheet characteristics included in the sheet type detection result for all the types, the medium is excluded from the selection target in step S504.

The sheet type selection processing unit 254 may determine, from among the basic media and the user defined media, a medium with the same sheet characteristics as those included in the sheet type detection result set in the largest number of types of the sheet characteristics, to be the medium selected in step S504.

The sheet type selection processing unit 254 may select, from among the basic media and the user defined media, a medium to be selected in step S504, from the media with the details of the sheet characteristics set thereto being the same as those included in the sheet type detection result for a predetermined number or more types of sheet characteristics. The sheet type selection processing unit 254 may select, from among the basic media and the user defined media, a medium to be selected in step S504, from the media with the details of the sheet characteristics set thereto being the same as those included in the sheet type detection result for a predetermined type of sheet characteristics. The sheet type selection processing unit 254 may select, from among the basic media and the user defined media, a medium to be selected in step S504, from the media with the differences from the details of the sheet characteristics included in the sheet type detection result falling within a predetermined range for the predetermined number or more of the types of the sheet characteristics. The sheet type selection processing unit 254 may select, from among the basic media and the user defined media, a medium to be selected in step S504, from the media with the differences from the sheet characteristics included in the sheet type detection result falling within a predetermined range for a predetermined type of characteristic. The predetermined number may be one or more. The predetermined type of characteristic may be determined, for example, based on a degree of influence on print quality.

In a case where one medium cannot be selected using one condition, the sheet type selection processing unit 254 may select one medium using, for example, a combination of a plurality of conditions.

For example, assume that there is a plurality of media to which the sheet characteristics that match those included in the sheet type detection result for a predetermined number or more of types of sheet characteristics are set, from among the basic media and the user defined media. In this case, the sheet type selection processing unit 254 may search the plurality of media for media having differences between the details of characteristics different from the details of the sheet characteristics included in the sheet type detection result, and the details of the sheet characteristics included in the sheet type detection result falling within a predetermined range. If the number of the media found in this way is one, the sheet type selection processing unit 254 selects the medium.

The display instruction processing unit 258 displays a list 602 of the sheet types selected in step S504, on the instruction/display unit 205.

FIG. 6B illustrates an example case where the grammage being 165 to 176 g/m², and the surface property being a coated sheet are included in the sheet type detection result as the sheet characteristics. FIG. 6B further illustrates an example of a case where a medium with the grammage being 176 g/m² and the surface property being high-quality paper is selected in step S504, as a medium (sheet type) with the characteristics similar to the sheet characteristics included in the sheet type detection result.

In step S504, there may be a case where the sheet type selection processing unit 254 determines that there is no medium with the characteristics similar to the sheet characteristics included in the sheet type detection result, in the basic media and the user defined media. In this case, the display instruction processing unit 258 may display information indicating the absence on the instruction/display unit 205.

Referring back to FIG. 5, in step S505, the sheet type determination processing unit 255 determines whether a medium (sheet type) with the characteristics similar to the sheet characteristics included in the sheet type detection result is selected in step S504. As a result of this determination, the medium (sheet type) with the characteristics similar to the sheet characteristics included in the sheet type detection result is selected (YES in step S505), the processing proceeds to step S506. On the other hand, in a case where the medium (sheet type) with the characteristics similar to the sheet characteristics included in the sheet type detection result is not selected (NO in step S505), the processing of the flowchart in FIG. 5 is ended.

In step S506, the sheet type combination processing unit 256 creates a new user defined medium, based on the print adjustment values set to the medium (sheet type) selected in step S504, and the details of the sheet characteristics included in the sheet type detection result. For example, assume that the details of the sheet characteristics and the print adjustment values set to the medium selected in step S504 are as illustrated in FIGS. 4C and 4D, respectively. In this case, the sheet type combination processing unit 256 duplicates values (print adjustment values) of the print adjustment parameters (“Saddle stitching fold position adjustment” 408 and others) illustrated in FIG. 4D, as the print adjustment values of the user defined medium to be newly created. The sheet type combination processing unit 256 sets the sheet characteristics included in the sheet type detection result as the sheet characteristics of the user defined medium to be newly created. In this case, the sheet characteristics (name 405, grammage 406, size 407, and the like) illustrated in FIG. 4C are not reflected on the sheet characteristics of the user defined medium to be newly created.

The display instruction processing unit 258 displays a new user defined medium name 603 on the instruction/display unit 205. Then, the processing of the flowchart in FIG. 5 is ended. FIG. 6C illustrates an example of a case where the new user defined medium name 603 is “Thick paper 4/A4_3New”. In addition, the new user defined medium name 603 may be created automatically by the sheet type combination processing unit 256, or may be a name designated by the user.

In a case where there is, in the basic media and the user defined media, a medium with the details of the sheet characteristics set thereto being the same as the details of the sheet characteristics included in the sheet type detection result for all the types of the sheet characteristics, for example, the processing described below may be performed. Specifically, the display instruction processing unit 258 displays on the instruction/display unit 205 that there is a sheet type (medium) with the completely same details of the sheet characteristics as those in the sheet type detection result. In this way, a user can recognize that a new sheet type (medium) does not need to be registered. At this time, the display instruction processing unit 258 may display, on the instruction/display unit 205, a graphical user interface (GUI) for prompting a user to select whether to continue further creating a new user defined medium. This operation is performed, for example, between steps S504 and S505, or between steps S505 and S506. In the case where the user is prompted to select whether to continue creating a new user defined medium, if the selection to continue creating a new user defined medium is made, the processing in step S506 is performed. On the other hand, if the selection to continue creating a new user defined medium is not made, the operations in the flowchart thereafter in FIG. 5 is not performed.

In the printing industry, various types of and wide variety of types of sheets are used. Thus, it is impossible for the image forming apparatus 100 to have print adjustment values for all the sheet types in advance. Accordingly, the image forming apparatus 100 stores the print adjustment values for the basic media (print adjustment values of representative sheet types frequently used by users). Since the print adjustment values set to the basic media stored in the image forming apparatus 100 are those for representative sheet types, there is a case where the print adjustment values to be applied to the sheet actually used for printing do not match therewith.

To achieve the best print, it is desirable for a user to create and use a medium (sheet type) to which the print adjustment values matching the sheet to be used for the printing are set at each time of printing. In this case, the user can obtain a print result based on the print adjustment values set by the user themselves, by creating a user defined medium and storing it in the image forming apparatus 100. However, if the user manually sets the details of the sheet characteristics and the print adjustment values individually, the user's workload increases (refer to FIGS. 4C and 4D). Further, there is a case where the user does not know which items (items of sheet characteristics and print adjustment parameters) are to be changed.

For this issue, in the present exemplary embodiment, the image forming apparatus 100 selects a medium with the characteristics similar to the sheet characteristics included in the sheet type detection result, from among already-existing media (basic media and user defined media). The image forming apparatus 100 creates a new user defined medium by combining the details of the sheet characteristics included in the sheet type detection result and the print adjustment values set to the medium. In this way, the user's workload at a time of setting the print adjustment parameter values depending on the sheet type can be reduced.

Next, a second exemplary embodiment will be described. In the first exemplary embodiment, the description has been provided of an example in which a medium with the characteristics similar to the sheet characteristics included in the sheet type detection result is selected, and a new user defined medium is created unconditionally using the print adjustment values set to the selected medium (sheet type). In contrast, in the present exemplary embodiment, a description will be provided of an example of a case where a medium selected by a user from among the media with the characteristics similar to the sheet characteristics included in the sheet type detection result is used for creating a new user defined medium. Thus, the present exemplary embodiment and the first exemplary embodiment are mainly different in the processing for selecting a medium to be used for creating a user defined medium. Thus, the same portions as those in the first exemplary embodiment are assigned the same numeral numbers as those in FIGS. 1 to 6C, and detailed descriptions thereof are omitted.

With reference to FIGS. 6A to 8, an example of processing of creating a user defined medium according to the present exemplary embodiment will be described.

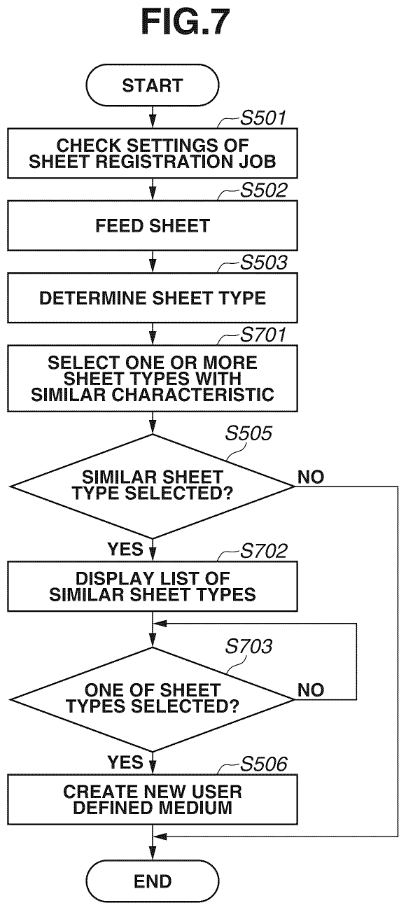

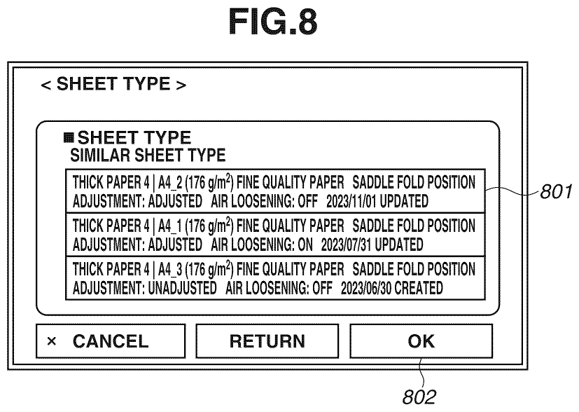

FIG. 7 is a flowchart illustrating an example of processing of newly creating a user defined medium. FIG. 8 is a diagram illustrating an example of a screen displayed when a user selects a medium with the characteristics similar to the sheet characteristics included in the sheet type detection result being set thereto. FIG. 8 is the diagram schematically illustrating an example of a screen displayed on the instruction/display unit 205.

The flowchart illustrated in FIG. 7 is implemented by, for example, the CPU 201 reading a control program stored in the storage unit 202, loading the read control program into the RAM 203, and executing the loaded control program.

Operations to be performed in steps S501 to S503 in FIG. 7 may be the same as those performed in steps S501 to 503 in FIG. 5.

More specifically, in step S501, the job processing unit 257 checks setting details of a sheet registration job. Next, in step S502, the job processing unit 257 feeds a sheet based on the setting of the sheet registration job. Next, in step S503, the sheet type detection processing unit 253 stores the sheet type detection result in the RAM 203. After completion of the processing in step S503, the processing proceeds to step S701.

In step S701, the sheet type selection processing unit 254 reads the sheet type detection result stored in the RAM 203. The sheet type selection processing unit 254 selects one or more (desirably more than one) media having characteristics similar to the sheet characteristics included in the sheet type detection result from among the basic media and the user defined media stored in the storage unit 202. Then, the processing proceeds to step S702.

As in step S504 in FIG. 5, the similar medium selected in step S701 is a medium (sheet type) with the characteristics similar to the sheet characteristics included in the sheet type detection result. In step S701 also, the media with the details of the sheet characteristics included in the sheet type detection result in all types of the characteristics, from among the basic media and the user defined media, are excluded from the selection targets.

The number of the similar media selected in step S504 is one, but the number of the similar media selected in step S701 is not limited to one. The condition for the similar media selected in step S701 is determined so that the number of the similar media to be selected in step S701 may be two or more.

For example, the sheet type selection processing unit 254 may select in step S701 media (sheet types) each with the weighted average described in the first exemplary embodiment being a predetermined value or less.

The sheet type selection processing unit 254 may select in step S701, from among the basic media and the user defined media, media with the details of the characteristics same as those included in the sheet type detection result for a predetermined number or more of types of characteristics. The sheet type selection processing unit 254 may select in step S701, from among the basic media and the user defined media, media to which the same details of the sheet characteristics as those included in the sheet type detection result for a predetermined type of characteristic are set. The sheet type selection processing unit 254 may select in step S701, from among the basic media and the user defined media, media each with the differences from the values of the sheet characteristics included in the sheet type detection result being within a predetermined range for a predetermined number or more of types of characteristics. The sheet type selection processing unit 254 may select in step S701, from among the basic media and the user defined media, media each with the differences from the values of the sheet characteristics included in the sheet type detection result being within a predetermined range for a predetermined type of characteristic. The predetermined number may be 1 or more. The predetermined type of characteristic may be, for example, determined based on a degree of influence on print quality.

The sheet type selection processing unit 254 may select a medium, for example, using a combination of a plurality of conditions. For example, initially, the sheet type selection processing unit 254 selects, from among the basic media and the user defined media, media (or medium) with the same sheet characteristics as those included in the sheet type detection result being set for the predetermined number or more of types of characteristics. Next, the sheet type selection processing unit 254 searches the plurality of media for any medium with differences between the details of the characteristics different from the details of the sheet characteristics included in the sheet type detection result, and the details of the sheet characteristics included in the sheet type detection result falling within a predetermined range. The sheet type selection processing unit 254 determines the media (or medium) found in this way as the media (or medium) selected in step S701.

Next, in step S505, the sheet type determination processing unit 255 determines whether a medium (sheet type) with the characteristics similar to the sheet characteristics included in the sheet type detection result is selected in step S701. As a result of this determination, the medium (sheet type) with the characteristics similar to the sheet characteristics included in the sheet type detection result is selected (YES in step S505), the processing proceeds to step S702. On the other hand, the medium (sheet type) with the characteristics similar to the sheet characteristics included in the sheet type detection result is not selected (NO in step S505), the processing of the flowchart in FIG. 7 is ended. In addition, the operation in step S505 may be omitted.

Next, in step S702, the display instruction processing unit 258 displays a list 801 of the sheet types selected in step S701, on the instruction/display unit 205. Then, the processing proceeds to step S703.

In the list 602 of the sheet types displayed in step S504 in FIG. 5, a sheet type (medium) determined to be used for creating a new user defined medium is displayed in a “Similar sheet type” field (refer to FIG. 6B). In contrast, as exemplified in FIG. 8, in a list 801 of the sheet types displayed in step S702, candidates for the sheet types (media) to be used for creating a new user defined medium are displayed in “Similar sheet type” fields. FIG. 8 illustrates an example in which three sheet types (media) are selected in step S701.

In step S701, there can be a case where the sheet type selection processing unit 254 determines that there is no medium with the characteristics similar to the sheet characteristics included in the sheet type detection result, in the basic media and the user defined media. In this case, the display instruction processing unit 258 may display information indicating the absence on the instruction/display unit 205.

Next, in step S703, the display instruction processing unit 258 waits until one of the sheet types (media) is selected from the list 801 of the sheet types displayed on the instruction/display unit 205 (NO in step S703). A sheet type in the list 801 of the sheet types is selected, by selecting one of the sheet types displayed in the list 801 of the sheet types, and then pressing an “OK” button 802. In a case where the user selects one sheet type from the list 801 of the sheet types (YES in step S703), the processing proceeds to step S506.

In step S506, the sheet type combination processing unit 256 creates a new user defined medium, based on the print adjustment values set to the sheet type (medium) selected in step S703, and the details of the sheet characteristics included in the sheet type detection result.

The display instruction processing unit 258 displays the new user defined medium name 603 on the instruction/display unit 205. Then, the processing of the flowchart in FIG. 5 is ended.

As described above, in the present exemplary embodiment, the image forming apparatus 100 selects, from among the basic media and the user defined media, media with the characteristics similar to the sheet characteristics included in the sheet type detection result as candidates for the media to be used for creating a new user defined medium. The image forming apparatus 100 creates the new user defined medium by combining the sheet characteristics included in the sheet type detection result and the print adjustment values set to the medium selected by the user from the candidates. In this way, it is possible to reduce the user's workload when the user sets the print adjustment values corresponding to the sheet type, as compared to a case where the user manually sets the individual print adjustment values. In the present exemplary embodiment, it is possible to set, to the new user defined medium, the print adjustment values close to the print adjustment values desired by the user.

The display form of the list 801 of the sheet types selected in step S701 is not limited. For example, information indicating a determination index used when the sheet type (medium) is selected may be displayed in the list 801 of the sheet types illustrated in FIG. 8. For example, information indicating the differences between the sheet characteristics set to a sheet type (medium) and the sheet characteristics included in the sheet type detection result may be displayed for each sheet type (medium) included in the list 801 of the sheet types. With reference to the information, the user can select a sheet type from the list 801 of the sheet types.

Next, a third exemplary embodiment will be described. In the second exemplary embodiment, the description has been provided of the example in which a medium (sheet type) selected by a user from among the media (sheet types) with the characteristics similar to the sheet characteristics included in the sheet type detection result is used as a medium to be used for creating a new user defined medium. In a case where there are many media (sheet types) with the characteristics similar to the sheet characteristics included in the sheet type detection result, the user is to select one medium from the many media. Thus, in the present exemplary embodiment, an example case where the sheet types (media) to be displayed in the list of sheet types are limited, to facilitate user's selection of a medium (sheet type) will be described. In this way, the present exemplary embodiment and the second exemplary embodiment are mainly different in the processing for selecting a medium to be used for creating a user defined medium. Accordingly, in descriptions of the present exemplary embodiment, the same portions as those in the first and second exemplary embodiments are assigned the same symbols as those in FIGS. 1 to 8, and detailed descriptions thereof are omitted.

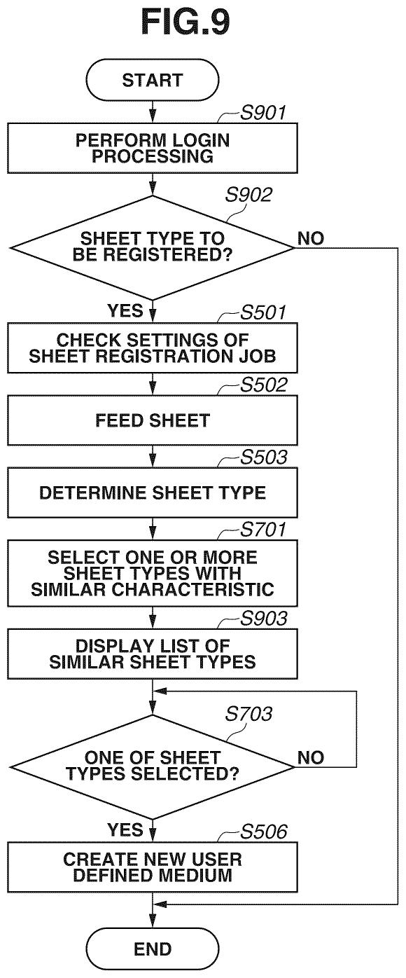

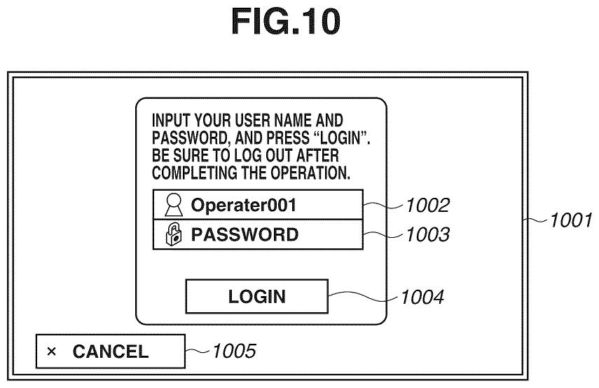

With reference to FIGS. 6A, 9, and 10, an example of user defined medium creation processing according to the present exemplary embodiment will be described. FIG. 9 is a flowchart illustrating an example of processing to be performed when a user defined medium is newly created. FIG. 10 is a diagram illustrating an example of a login screen 1001. FIG. 10 schematically illustrates the example of the screen displayed on the instruction/display unit 205.

The flowchart in FIG. 9 is implemented by, for example, the CPU 201 reading a control program stored in the storage unit 202, loading the read control program into the RAM 203, and executing the loaded control program. The flowchart in FIG. 9 starts, for example, when a user performs an operation to log in to the image forming apparatus 100, and the login screen 1001 illustrated in FIG. 10 is displayed on the instruction/display unit 205.

In step S901, user login processing is performed. When the user presses a “Login” button 1004 after inputting a login name 1002 and a password 1003 on the login screen 1001, the display instruction processing unit 258 performs the login processing using the input login name 1002 and the password 1003. In the login processing, the display instruction processing unit 258 identifies the user of the image forming apparatus 100. Then, the processing proceeds to step S902. In a case where a “Cancel” button 1005 is pressed, the login processing is not performed. In this case, the operations in step S902 and the subsequent steps are not performed, and the processing of the flowchart in FIG. 9 is ended.

In step S902, the sheet type management processing unit 252 determines whether a user has performed an operation to instruct performing registration processing of a sheet type on the instruction/display unit 205. In a case where the operation to instruct performing the registration processing of the sheet type has been performed (YES in step S902), the display instruction processing unit 258 displays the sheet type creation button 601 illustrated in FIG. 6A on the instruction/display unit 205. In a case where the sheet type creation button 601 is selected by the user (YES in step S902), the processing proceeds to step S501. In a case where the operation to instruct performing the registration processing of the sheet type has not been performed (i.e., operation so as not to perform the registration processing of the sheet type has been performed) (NO in step S902), the processing of the flowchart in FIG. 9 is ended.

The operations to be performed in steps S501 to S503 in FIG. 9 may be the same as those performed in steps S501 to S503 in FIGS. 5 and 7.

More specifically, in step S501, the job processing unit 257 checks setting details of a sheet registration job. Next, in step S502, the job processing unit 257 feeds a sheet based on the setting of the sheet registration job. Next, in step S503, the sheet type detection processing unit 253 stores the sheet type detection result into the RAM 203. After completion of the operation in step S503, the processing proceeds to step S701.

The operation in step S701 in FIG. 9 may be similar to that performed in step S701 in FIG. 7. More specifically, in step S701, the sheet type selection processing unit 254 selects, from among the basic media and the user defined media, one or more (desirably more than one) media with the characteristics similar to the sheet characteristics included in the sheet type detection result.

Then, the processing proceeds to step S903.

In step S903, the display instruction processing unit 258 displays, on the instruction/display unit 205, a list of the sheet types (user defined media) created by the user of the login name 1002 acquired by the login processing in step S901 from among the sheet types (media) selected in step S701. Then, the processing proceeds to step S702. Thus, in the present exemplary embodiment, an example case where the identification information about the user who has created the user defined media is stored in association with each of the user defined media, is exemplified. In step S702 in FIG. 7, a list of the sheet types (media) selected in step S701 is displayed on the instruction/display unit 205. In contrast, in step S903, a list of a part of the sheet types from among all the sheet types (media) selected in step S701 can be displayed on the instruction/display unit 205. Accordingly, the number of selection target sheet types can be reduced.

Next, in step S703, the display instruction processing unit 258 waits until one of the sheet types (media) is selected from the list 801 of the sheet types displayed on the instruction/display unit 205 in step S903. In a case where the user selects one sheet type from the list 801 of the sheet types (YES in step S703), the processing proceeds to step S506.

In step S506, the sheet type combination processing unit 256 creates a new user defined medium, based on the print adjustment values set to the sheet type (medium) selected in step S703, and the sheet characteristics included in the sheet type detection result.

The display instruction processing unit 258 displays the new user defined medium name 603 on the instruction/display unit 205. Then, the processing of the flowchart in FIG. 9 is ended.

As described above, in the present exemplary embodiment, the image forming apparatus 100 selects, from among the basic media and the user defined media, the user defined media with the characteristics similar to the sheet characteristics included in the sheet type detection result, and created by the login user. Accordingly, the candidates for the media to be used for a new user defined medium can be narrowed down. Thus, it is possible to further reduce the user's workload in a case where the print adjustment values close to the print adjustment values desired by the user are set to the new user defined medium.

In the present exemplary embodiment, in step S903, the example in which the display instruction processing unit 258 displays, on the instruction/display unit 205, the list of the sheet types created by the user with the login name 1002 obtained by the login processing, from among the sheet types (media) selected in step S701 has been described. The selection condition for selecting the sheet types to be displayed in the list from among the sheet types (media) selected in step S701 is not limited to the above-described condition. For example, the display instruction processing unit 258 may display new sheet types (media) in priority in the list of the sheet types, based on an update history of the print adjustment values. The display instruction processing unit 258 may display the sheet types (media) with more updated print adjustment values in priority in the list of the sheet types, based on a use history of the print adjustment values. In this case, the user name, the update history, and the use history are examples of information to be stored in association with the sheet type at a sheet type creation time or a sheet type update time.

According to the present disclosure, it is possible to reduce a user's workload when the user performs settings of the print adjustment parameter values corresponding to the sheet type.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-025192, filed Feb. 22, 2024, which is hereby incorporated by reference herein in its entirety.

What is claimed is:

1. A processing apparatus comprising:
at least one memory storing instructions; and
at least one processor that, upon execution of the stored instructions, is configured to operate as:
an identification unit configured to identify a characteristic of a sheet, based on a result of detection performed by a detection unit configured to detect a physical quantity having a value corresponding to the characteristic of the sheet while the sheet is being conveyed; and
a creation unit configured to create sheet type information including information indicating the characteristic of the sheet, and a print adjustment parameter corresponding to the characteristic,
wherein the creation unit creates new sheet type information, based on the characteristic of the sheet identified by the identification unit, and the print adjustment parameter included in sheet type information including a characteristic similar to the characteristic identified by the identification unit, from already-existing sheet type information.

2. The processing apparatus according to claim 1, wherein the similar characteristic includes characteristic that satisfies at least one of a detail thereof having a same detail of characteristic of the sheet identified by the identification unit for some types of characteristic, and a difference in detail from the characteristic of the sheet identified by the identification unit falling within a predetermined range for at least some types of characteristic.

3. The processing apparatus according to claim 1, wherein the creation unit duplicates a value of the print adjustment parameter included in the sheet type information including the characteristic similar to the characteristic of the sheet identified by the identification unit as a value of a print adjustment parameter to be included in the new sheet type information.

4. The processing apparatus according to claim 1, wherein the creation unit includes the characteristic of the sheet identified by the identification unit in the new sheet type information.

5. The processing apparatus according to claim 1, wherein the creation unit selects, from the already-existing sheet type information, a piece of the sheet type information including the characteristic similar to the characteristic of the sheet identified by the identification unit, and automatically creates the new sheet type information, based on the characteristic of the sheet identified by the identification unit and the value of the print adjustment parameter included in the sheet type information.

6. The processing apparatus according to claim 1,
wherein the at least one processor is, upon execution of the stored instructions, further configured to operate as a display control unit configured to display, on a display device, information indicating the sheet type information including the characteristic similar to the characteristic of the sheet identified by the identification unit from the already-existing sheet type information, as information indicating a candidate for the sheet type information to be used for creating the new sheet type information, and
wherein the creation unit creates the new sheet type information, based on the characteristic of the sheet identified by the identification unit, and the value of the print adjustment parameter included in the sheet type information selected from among a plurality of the candidates.

7. The processing apparatus according to claim 6,
wherein the at least one processor is, upon execution of the stored instructions, further configured to operate as a selection unit configured to select sheet type information to serve as the candidate from among sheet type information in which the characteristic similar to the characteristic of the sheet identified by the identification unit is set, and
wherein the display control unit displays on the display device the information indicating the candidate selected by the selection unit.

8. The processing apparatus according to claim 7, wherein a condition for the sheet type information to serve as the candidate includes a condition using the information stored in association with the sheet type information at least at one of a time when the sheet type information is created, and a time when the sheet type information is updated.

9. A processing method, comprising:
identifying a characteristic of a sheet, based on a result of detection of a physical quantity having a value corresponding to the characteristic of the sheet while the sheet is being conveyed; and
creating sheet type information including information indicating the characteristic of the sheet, and a print adjustment parameter corresponding to the characteristic,
wherein, in the creating, new sheet type information is created based on the identified characteristic of the sheet, and the print adjustment parameter included in sheet type information including a characteristic similar to the identified characteristic, from already-existing sheet type information.

10. A non-transitory computer readable storage medium for storing a program causing a processing apparatus to perform a processing method, the processing method comprising:
identifying a characteristic of a sheet, based on a result of detection of a physical quantity having a value corresponding to the characteristic of the sheet while the sheet is being conveyed; and
creating sheet type information including information indicating the characteristic of the sheet, and a print adjustment parameter corresponding to the characteristic,
wherein, in the creating, new sheet type information is created based on the identified characteristic of the sheet, and the print adjustment parameter included in sheet type information including a characteristic similar to the identified characteristic, from already-existing sheet type information.
